(19) United States
(12) Patent Application Publication
(10) Pub. No.: US 2008/0028987 A1
(43) Pub. Date: Feb. 7, 2008

(54) Agent And Uses For Treating And Improving Building Materials, Mineral Mixtures And Mineral Colors, And Corresponding Method

(76) Inventor: Karsten Duda, Gerstetten (DE)

Correspondence Address: K.F. ROSS P.C., 5683 RIVERDALE AVENUE, SUITE 203 BOX 900, BRONX, NY, 10471-0900, US

(21) Appl. No.: 10/590,261

(22) PCT Filed: Feb. 11, 2005
(86) PCT No.: PCT/EP05/01588

§ 371 Date: Jun. 25, 2007

(30) Foreign Application Priority Data
Feb. 19, 2004 (EP) 04090058.1

(51) Int. Cl. C04B 28/02; C04B 22/06; C04B 22/10; C04B 24/08

(52) U.S. Cl. 106/287.26

(57) ABSTRACT

The invention relates to an agent and uses for treating and improving building materials, mineral mixtures and mineral colours, and to a corresponding method. The aim of the invention is to create an agent, a method and uses of the above-mentioned type which enable old and new capillary-porous building materials, mineral mixtures and mineral colours to be rendered hydrophobic, with both high efficacy and a simple handling process, simultaneously providing the same with a long period of protection, and/or to protect said materials from humidity, without affecting a subsequent coating of the material, the mineral mixture or the mineral colour, without strongly reducing the vapour permeability thereof, and without modifying the inherent colour of the same. To this end, the agent contains between 60.0 and 75.0 mass % of water, between 15.0 and 22.0 mass % of soap, between 1.0 and 7.0 of mass % of a carbonate compound, between 2.0 and 6.0 mass % of sodium hydroxide, and between 1.0 and 7.0 mass % of filler.

The invention refers to an agent for treating, especially impregnating, sealing, retaining, consolidating, preserving, drying and/or keeping dry of capillary porous building materials such as bricks, natural stones and sand-lime bricks and/or concrete building materials, an agent for improving, especially making hydrophobic, retaining and consolidating of mineral mixtures such as mortar, floor pavements, sludge and concrete as well as an agent for making hydrophobic of mineral colors.

The invention also relates to an agent for treating, especially making hydrophobic, impregnating, sealing, retaining, consolidating, preserving, drying and/or keeping dry of capillary porous building materials such as bricks, natural stones and sand-lime bricks and/or concrete building materials, furthermore a method for improving, especially making hydrophobic, retaining and consolidating of mineral mixtures such as mortar, floor pavements, sludge and concrete as well as a method for making hydrophobic of mineral colors.

Furthermore, the invention relates to the use of the agent for making hydrophobic, impregnating, sealing, retaining, consolidating, preserving, drying and/or keeping dry of capillary porous building materials such as bricks, natural stones and sand-lime bricks and/or concrete building materials, furthermore the use for improving, especially making hydrophobic, retaining and consolidating of mineral mixtures such as mortar, floor pavements, sludge and concrete as well as the use for making hydrophobic of mineral colors.

From DE 38 04 741 A1 is known a mortar with a agent for drying and/or keeping dry walling with silicates and carbonates which contains 30 to 50 weight-% calcium hydroxide, 5 to 20 weight-% soap, 25 to 40 weight-% water, 0.5 to 5 weight-% carbonate compound, 1 to 8 weight-% silicate compound and 0.5 to 5 weight-% filling materials. This known mortar shall be applicable for drying and/or keeping dry wet or penetrated with moisture walling. This may be absolutely true with regard to the external protection of the walling against moisture penetrating from the surface by plastering it.

But existing walling by plastering can not be protected against ascending moisture or wetness. Also it is not possible to dry or keep dry wet walling by only plastering it with a mortar. This only is reached by horizontal retaining layers which have to be built into the existing walling. For this the known mortar can not be used, because the high content of calcium hydrate and/or calcium hydroxide leads to a very strong water repellent reaction and to a very fast choking of the distribution agent, for example capillary tubes or injection packers. The high content of calcium is responsible also for the fact, that the treated ground has no adhesiveness for following painting or adhesive coating.

For the rehabilitation of walling, especially for drying or placing horizontal retaining layers it is known (for example DE 42 00 122 A1) to place hydrophobic or sealing solutions via drilled holes and injection packers or capillary tubes into the walling. Until now only were used injection or impregnation solutions on the basis of synthetic materials like compounds with isocyanate groups (DE 197 06 904 A1), organoalcoxysilane (DE 195 13 238 A1, DE 196 05 674 A1, EP 344 919 B1), water-in-oil emulsions (DE 101 30 091 A1), siliconorganic compounds (DE 39 11 479 A1) that create a moisture-proof horizontal retaining layer in the walling by cross linking or chemical reaction.

From DE 44 18 441 A1 also is known a resinogenic material consisting of vegetable oils with corresponding ester derivatives for sealing porous building surfaces against moisture.

All these agents have the common disadvantage that each of the known agents can be used only for one special purpose and thus insignificantly limited with regard to its range of use. Therefore, dependant on the requirements different impregnation or injection agent have to be used which in addition have to be not critical with regard to toxicity, inflammability and odor.

Proceeding from this state of the art, the invention has the task to provide an agent, a method and uses of the kind mentioned at the beginning, which make it possible to make hydrophobic and/or seal against moisture capillary porous building materials of ancient buildings and buildings under construction, mineral mixtures, and mineral colors alike with high efficiency and convenient handling, reaching a long term protection without using solvents and synthetic resins and without restricting a following coating of the building material, heavily reducing its vapor permeability and changing the inherent color of the building material, the mineral compound or the mineral color.

This task is solved by an agent of the kind mentioned in the beginning with the characterizing features of claims 1 to 3, by a method with the characterizing features of claims 9, 18 and 28 as well as an use according to claims 3 to 35.

Advantageous aspects can be taken from the sub-claims.

The agent according to this invention above all stands out for the fact, that for the first time it has been succeeded in providing a pure inorganic agent which can be used for the preventive or also subsequent moisture protection of building materials, the improvement of mortar, floor pavements, sludge or concrete as well as for making hydrophobic of mineral colors alike.

This makes it possible to apply the agent according to this invention for impregnating, sealing and preserving of capillary porous building materials in ancient buildings and buildings under construction, the sealing and preservation of surfaces, the implementation of horizontal retaining layers against ascending moisture in walling as well as the permanent drying and keeping dry of walling.

The agent according to this invention contains components which are free of solvents and synthetic resins, without smell and generally recognized as safe with regard to toxicology. The agent goodly and deeply infiltrates into the capillary porous structure of the building material without clogging the pores, what improves the diffusibility. The protective effect against penetrating moisture or water of the agent according to this invention lasts for a long time without a decrease in effectiveness, efflorescence of salt and moldiness are prevented durably.

Surface sealing produced according to the method of this invention are alkali-resistant, resistant to damaging environmental impacts and can be coated without problems with plaster and/or paintings or tiles.

The agent according to this invention can be brought into the capillary porous building material as single-component solution by impregnation or penetration under low pressure as well as under high pressure. The up to now common method to drill holes into the walling and to bring the single-component solution of the agent according to this invention via capillary tubes into the walling can be maintained as well as the work with packers to create a horizontal retaining layer.

Also for improving mineral mixture, for example rehabilitation mortar, sealing mortar, floor pavements, sealing floor pavements and sludge and concrete the agent according to this invention can be used with exceptional advantages. It is simply added to the mixing water and to a high extend limits the capillary conductivity of the mineral mixture, so that they acquire water retaining properties.

It only has to be paid attention that in accordance with the respective problem definition the amount of water added to the respective mineral compound is within the limits.

For example, when the task is to create a horizontal retaining layer in an ancient walling the agent according to this invention is to be mixed in a ration of 1:15 and to be brought into the walling by packers via the drilled holes.

Mineral colors also can be made hydrophobic with the agent by adding the solution to the diluted dispersion of inorganic vehicles such as lime, white cement or silicate colors (potassium silicate) used as paint.

In the following the invention shall be illustrated in more detail with reference to several aspects.

### Embodiment 1

A horizontal retaining layer shall be retrofitted into an ancient walling. The existing plaster is knocked off up to about 30 to 50 cm above the designated for this area and loose material is removed. The joints are raked out up to 3 to 5 cm in depth and all surfaces are cleaned free of dust.

Applied is an agent according to this invention of the following composition:

| | |
|---|---|
| Water | 72 mass-% |
| Curd soap | 17 mass-% |
| Potassium carbonate | 4 mass-% |
| Sodium hydroxide | 3 mass-% |
| White barium sulphate | 4 mass-%. |

This agent is mixed with pure tap water in a ratio of one proportion of the agent to 8 proportions of water.

Then the mortar for the joints is mixed with the mixing water, whereby the raked off joints are moistened with the mixing water beforehand. Afterwards the joints are pointed “wet-on-wet”.

After a drying time of about 3 days into the walling are drilled two rows of holes lying parallel above each other. The drilled holes of one row have a distance of about 10 cm from each other and are positioned on one line. The drilled holes of the upper row thereby are positioned in such a way, that they are staggered in relation to the drilled holes of the lower row. Into the drilled holes then are placed common packers which are connected to a low pressure filling equipment for injection. As injection solution is applied the above mentioned in more detail specified agent, which is diluted with water in a ratio of 1:15. At first the drilled holes of the lower row are filled with the injection solution which is pressed with a pressure of 2 to 4 bar into the capillary structure surrounding the drilled holes until the structure is fully impregnated. Then the upper drilled holes are filled under pressure.

With respect to the concrete demand to the horizontal retaining layer the mixing ratio may vary between 1:8 to 1:15. After the capillary structure has been fully impregnated with injection solution and the latter has hardened the drilled holes are filled with swelling concrete or swelling mortar.

The respective areas of the walling afterwards are coated with rehabilitation plaster to which the agent according to this invention was added in the mixing water in a ratio of 1:8 to 1:10. The contents of the agent are the same as in the composition mentioned in the beginning with the difference, that in place of the white barium sulphate is applied a grey barium sulphate.

### Embodiment 2

A wall of an ancient walling shall be impregnated with the agent according to this invention.

An impregnation solution is produced of the agent according to this invention consisting of 60 mass-% water, 22 mass-% curd soap, 6 mass-% potassium carbonate, 6 mass-% sodium hydroxide and 6 mass-% white barium sulphate by adding 12 proportions of water to 1 proportion of the agent according to this invention and by stirring. The use of the impregnation solution is carried out by means of the flood method on the thoroughly cleaned wall surface, free of dust and dried.

After drying develops a surface which is weathering resistant, dirt repelling and can be painted on.

### Embodiment 3

A sand-lime brick walling shall be prepared for coating with plaster with a primer for consolidating the ground. One proportion of the agent according to this invention consisting of 71 mass-% water, 18 mass-% curd soap, 4 mass-% potassium carbonate, 3 mass-% sodium hydroxide and 4 mass-% grey barium sulphate is mixed by stirring with 9 proportions of water to produce the necessary quantity of primer solution.

Before applying the primer solution the ground has to be freed of old, brittle or contaminated plaster. The joints have to be raked out up to a depth of at least 20 mm and all surfaces have to be cleaned from dust and other remainders by dry or wet blasting.

The use of the primer solution is carried out as described in embodiment 2.

The primer solution deeply penetrates into the porous structure of the building material, consolidates the surface and develops a solid water repelling zone.

### Embodiment 4

A heavily contaminated with harmful to buildings salts historical walling with a salt content of 3 to 6 mass-% shall get a new plaster.

To the total quantity of mixing water for the plaster mortar are added 10 percent by volume of the agent according to this invention, whereby the agent according to this invention is diluted in a ratio of 1:10. The agent according to this invention contains 71 mass-% water, 18 mass-% curd soap, 3.4 mass-% potassium carbonate, 3.4 mass-% grey barium sulphate and 4.2 mass-% sodium hydroxide.

The mortar is mixed in a compulsory mixer and applied in one layer with a layer thickness of 2 cm. The treatment of the surface also was carried out according to the historical paragon. The plaster has a life time of more than 20 years.

### Embodiment 5

A splash socle which contains between 5 and 10 mass-% of water caused by ascending moisture shall be newly plastered. The socle after plastering has to have a good appearance, i.e. no water spots or other color changes may be realized. Furthermore, the socle has to have water repellent features which prevent the penetration of splash water.

To the mixing water for the plaster mortar are added 10 to 12 percent by volume of the agent according to this invention, what corresponds with a dilution of the agent according to this invention of 1:10 to 1:12.

This mortar is put into a compulsory mixer, mixed and afterwards applied in one layer with a thickness of 2 cm and abraded after setting. The plaster has a life time of more than 20 years. Because the plaster is water repellent it is only insignificantly polluted by splashing water. A paint coating is not necessary.

1. Agent for treating, especially impregnating, sealing, retaining, consolidating, preserving, drying and/or keeping dry of capillary porous building materials such as bricks, natural stones and sand-lime bricks and/or concrete building materials, characterized in that the agent contains 60.0 to 75.0 mass-% water, 15.0 to 22.0 mass-% soap, 1.0 to 7.0 mass-% of a carbonate compound, 2.0 to 6.0 mass-% sodium hydroxide and 1.0 to 7.0 mass-% filling materials.

2. Agent for improving, especially making hydrophobic, retaining and consolidating of mineral mixtures such as mortar, floor pavements, sludge and concrete, characterized in that the agent contains 60.0 to 75.0 mass-% water, 15.0 to 22.0 mass-% soap, 1.0 to 7.0 mass-% of a carbonate compound, 2.0 to 6.0 mass-% sodium hydroxide and 1.0 to 7.0 mass-% filling materials.

3. Agent for making hydrophobic of mineral colors, characterized in that the agent contains 60.0 to 75.0 mass-% water, 15.0 to 22.0 mass-% soap, 1.0 to 7.0 mass-% of a carbonate compound, 2.0 to 6.0 mass-% sodium hydroxide and 1.0 to 7.0 mass-% filling materials.

4. Agent according to claim 1, 2, or 3, characterized in that the soap is a curd soap.

5. Agent according to claim 1, 2, or 3, characterized in that the carbonate compound is potassium carbonate.

6. Agent according to claim 1, 2, or 3, characterized in that the weight proportions of the carbonate compound and the filling materials are matched one to the other.

7. Agent according to claim 6, characterized in that the weight proportions are equal one to another.

8. Agent according to claim 7, characterized in that the filling material contains barium sulphate, French chalk, titanium dioxide, marble powder, feldspar or a mixture of these materials.

9. Method for treating, especially making hydrophobic, impregnating, sealing, retaining, consolidating, preserving, drying and/or keeping dry of capillary porous building materials such as bricks, natural stones and sand-lime bricks and/or concrete building materials with a agent according to claim 1, characterized in that for the treatment is applied an agent containing 60.0 to 75.0 mass-% water, 15.0 to 22.0 mass-% soap, 1.0 to 7.0 mass-% of a carbonate compound, 2.0 to 6.0 mass-% sodium hydroxide and 1.0 to 7.0 mass-% filling materials, that is diluted with 8 to 15 proportions of water and applied on the walling or brought into the walling.

10. Method according to claim 9, characterized in that as soap is used curd soap.

11. Method according to claim 9, characterized in that as carbonate compound is used potassium carbonate.

12. Method according to claim 9, characterized in that the weight proportions of the carbonate compound and the filling materials are matched one to the other.

13. Method according to claim 9, characterized in that the ratio of carbonate compound and filling materials is adjusted to about 1:1.

14. Method according to claim 9, characterized in that as filling material is used barium sulphate, French chalk, titanium dioxide, marble powder, feldspar or a mixture of these materials.

15. Method according to claim 9, characterized in that the agent for the impregnation of the walling is diluted with 10 to 12 proportions of water.

16. Method according to claim 9, characterized in that for sealing and retaining of the walling by a horizontal retaining layer the agent is diluted with 8 to 15 proportions of water.

17. Method according to claim 9, characterized in that for consolidating (priming) the surface of the walling the agent is diluted with 9 to 10 proportions of water.

18. Method for improving, especially making hydrophobic, retaining and consolidating of mineral mixtures such as mortar, floor pavements, sludge and concrete with an agent according to claim 2, characterized in that for improving is used an agent containing 60.0 to 75.0 mass-% water, 15.0 to 22.0 mass-% soap, 1.0 to 7.0 mass-% of a carbonate compound, 2.0 to 6.0 mass-% sodium hydroxide and 1.0 to 7.0 mass-% filling materials that is added to the mixing water for mortar, floor pavements, sludge or concrete in a ratio of 1:8 to 1:12.

19. Method according to claim 18, characterized in that as soap is used curd soap.

20. Method according to claim 18, characterized in that as carbonate compound is used potassium carbonate.

21. Method according to claim 18, characterized in that the weight proportions of the carbonate compound and the filling materials in the agent are matched one to the other.

22. Method according to claim 21, characterized in that the ratio of carbonate compound and filling materials is adjusted to about 1:1.

23. Method according to claim 18, characterized in that as filling material is used barium sulphate, French chalk, titanium dioxide, marble powder, feldspar or a mixture of these materials.

24. Method according to claim 18, characterized in that the agent is diluted with 8 to 10 proportions of water.

25. Method according to claim 18, characterized in that for the rehabilitation plaster the agent is diluted with 10 proportions of water.

26. Method according to claim 18, characterized in that for the retaining plaster the agent is diluted with 8 proportions of water.

27. Method according to claim 18, characterized in that the agent for retaining floor pavements or sludge is diluted with 8 to 10 proportions of water.

28. Method for making hydrophobic of mineral colors, characterized in that for making the colors hydrophobic is used an agent containing 60.0 to 75.0 mass-% water, 15.0 to 22.0 mass-% soap, 1.0 to 7.0 mass-% of a carbonate compound, 2.0 to 6.0 mass-% sodium hydroxide and 1.0 to 6.0 mass-% filling materials that is added to the mineral color as dilution and mixed with it by stirring.

29. Method according to claim 28, characterized in that as soap is used curd soap.

30. Method according to claim 28, characterized in that as carbonate compound is used potassium carbonate.

31. Method according to claim 28, characterized in that the weight proportions of the carbonate compound and the filling materials in the agent are matched one to the other.

32. Method according to claim 31, characterized in that the ratio of carbonate compound and filling materials in the agent is adjusted to about 1:1.

33. Use of the agent according to claim 1 for making hydrophobic, impregnating, sealing, retaining, consolidating, preserving, drying and/or keeping dry of capillary porous building materials such as bricks, natural stones and sand-lime bricks and/or concrete building materials.

34. Use of the agent according to claim 2 for making hydrophobic, retaining and consolidating of mineral mixtures such as mortar, floor pavements, sludge and concrete.

35. Use of the agent according to claim 3 for making hydrophobic of mineral colors.
